(19) United States
(12) Patent Application Publication
(10) Pub. No.: US 2010/0245288 A1
(43) Pub. Date: Sep. 30, 2010

(54) Touch Tunnels

(75) Inventor: Scott C Harris, Rancho Santa Fe, CA (US)

Correspondence Address: SCOTT C HARRIS;Law Office of Scott C Harris, Inc, P O BOX 1389, Rancho Santa Fe, CA, 92067-1389, US

(73) Assignee: HARRIS TECHNOLOGY, LLC, Rancho Santa Fe, CA (US)

(21) Appl. No.: 12/413,571

(22) Filed: Mar. 29, 2009

(51) Int. Cl. G06F 3/042

(52) U.S. Cl. 345/175

(57) ABSTRACT

A touch screen that operates by conducting an environmental change—e.g heat, radiation such as light, or RF environment, to the other side where it can be detected. The shape of the actuating device can also be detected and used for analyzing whether to allow the actuation. One embodiment uses nano fibers or nano tubes to conduct the environmental change from the front side to the back side.

### BACKGROUND

Digit-activated screens, or “touchscreens” allow functions of a machine to be activated by a user's selection, e.g., with a finger or stylus. Various types of touchscreens are known. In some touchscreens, a display is created on the front surface screen, and the display on the screen prompts the user where to touch to command certain functions. Other touchscreens may have information permanently printed in locations, e.g, information such as numbers and letters. Touching the locations of those numbers or letters causes actuation of the screen at that area, and hence causes actuation of the function associated with that area.

For example, these letters may indicate things like arrow up/down, timers, power on and off, and the like. A user can touch an area near the symbols to actuate that function.

The screens in the prior art are of various types, e.g, detecting changes in capacitive or resistive characteristics. Other screens may detect deformation in the surface as their actuation.

These touchscreens are typically deformable screens, and are moved slightly when the user presses against them, e.g., with their finger or with a stylus.

However, deformable screens can be damaged. For example, a user's fingernail may deform the surface of a touch screen. Users often use implements such as pens or knives to touch the screen. This can damage the screen. When a touchscreen is used on a kitchen appliance, users often touch the screen with dirty fingers and leave marks that need to be cleaned.

Moreover, various specialized materials are typically used depending on the technology of the touchscreen under consideration. For example, for capacitive touchscreens, a capacitive material needs to be used.

### SUMMARY

An embodiment describes a touchscreen which conducts or “tunnels” an environmental change, from one side of the screen, the “outside”, to the other side of the screen, the “inside”. The environmental change commands an actuation of a command. The tunneling can be through multiple tunnels that extend between inside and outside of the screen. Those tunnels can include or be filled with fibers or nano tubes that conduct the environmental change, e.g, temperature sensing fibers or radiation, e.g., light conducting fibers, or crosstalk-conducting materials e.g., electrical conductors, for example.

An embodiment allows hard and non-deformable materials to be used for the surface of the screen. For example, the surface of the screen can be glass or metal or any other hard substance.

In one embodiment, the tunnels are formed with “nano fibers” that pass between the front and rear surface of the screen, which may conduct temperature, light, or other environmental changes.

An embodiment describes detecting an actuation before the screen is actually touched.

An embodiment describes characterizing a shape of the actuation, and determining if that shape matches a stored shape.

Another embodiment describes an isomorphic control, one embodiment of which allows the isomorphic control to minimize an amount of detail needed to control isomorphically.

### BRIEF DESCRIPTION OF THE DRAWINGS

These and other aspects will now be described in detail with reference to the accompanying drawings, wherein:

FIGS. 1 and 2A show a first embodiment of a touchscreen;

FIG. 2A shows a flowchart of detecting an actuation;

FIG. 2B shows a flowchart of training a finger or object;

FIG. 3 shows an embodiment with tunnels in the touchscreen;

FIGS. 4A and 4B show radiation (e.g., light) detecting embodiments;

FIG. 5 shows how the system can be used for an isomorphic control;

FIG. 6 shows a resonant frequency embodiment;

FIGS. 7A-7C illustrate a target-animation embodiment;

FIG. 8 shows a relaying and curving of the detection embodiment.

### DETAILED DESCRIPTION

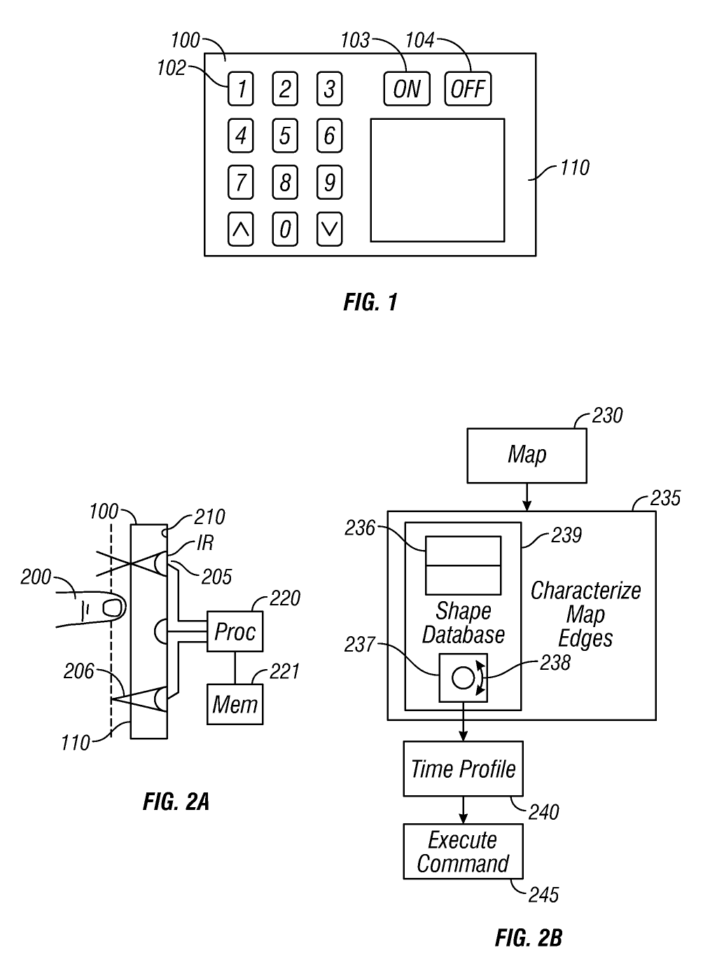

The touchscreen shown in FIG. 1 includes a flat surface 100 formed of a hard material—e.g., tempered glass, stainless steel or hard plastic. Different controls, such as numbers 102 or functions 103, 104 are shown on the touchscreen, e.g., by a permanent printing, or by displaying an image. The touchscreen can be actuated without deforming the surface at all.

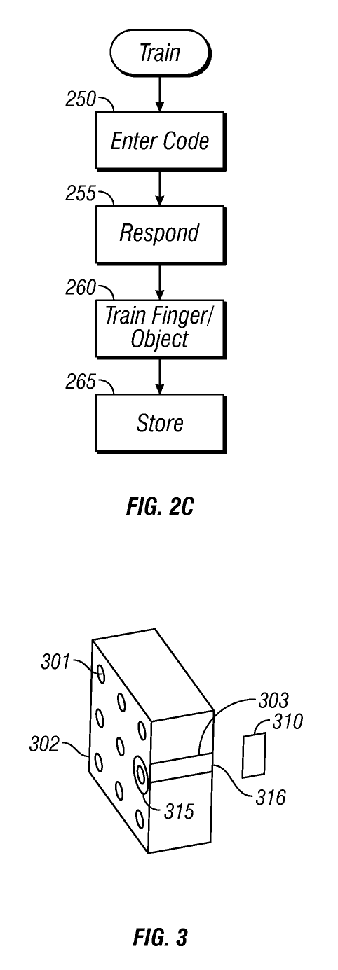

FIG. 2A illustrates a side view of the touchscreen 100. In the embodiment of FIGS. 1 and 2, human body parts such as 200 can be sensed. However, anything that has any characteristics different than the air can in general be sensed. For example, this can sense the characteristics of plastic, e.g, a stylus or a fake fingernail.

Note the human body part is such as a finger 200. The finger 200 is brought close to the front surface 100 of the touch screen. A sensor array 210 is located in a location where it can sense the change in environment caused by the approaching of the finger. In one embodiment, this can be on the back surface of the screen or behind the front surface. A sensor array 210 can be, for example, an array of infrared sensors,radiation sensors for light or other radiation, frequency sensors such as antennas or other kinds of sensors.

The array of sensors 210 includes a number of individual sensors such as 205. The array of sensors is “focused” on the area 206, encompassing the front surface 110, where the focus can be by a lens, or can be the field of view of the sensor.

The sensor array 200 is coupled to a processor 220, which forms a map of the sensed environmental condition near the front surface, for example, a temperature profile over an area near the front surface 100. The map can be either a two dimensional map or a three dimensional map. The 3D map can be used with the embodiments which detect an item coming close to the screen before and/or without actually touching the screen.

The processor 220 can carry out the routine shown in FIG. 2B. At 225, a map routine is carried out. This represents the processor forming a map of the sensed environmental condition at an area sensed at the front surface. In this embodiment, the sensors may sense multiple points forming pixels. In one embodiment, there is a separate sensor for each pixel. In another embodiment, one sensor can detect an entire area, and each “point” of the area forms a pixel.

At 235, the edges of the area on the map are determined. As shown by 235, this might distinguish between areas such as 236 where there is a warm and a cold spot (in the IR embodiment) separated by a line. There can also be areas such as 237 in which the warm spot has an outer shape of an oval, for example. The shape shown as 236 represents a line as would be formed by sun glare; while in contrast, the line shown by 237 is such as would be formed by a finger. Shapes which represent acceptable shapes for an actuation can be stored in shape database 239 and matched against a current shape. Analogously, non acceptable shapes such as 236 can also be stored, and matching to those non-acceptable shapes prevents the actuation.

Other similar shapes could represent a nail, or a stylus or others can be stored in the shape database. The shapes in the database can be prestored, and/or can be trained.

The matching of the found shape to the stored shape can also use rotation shown as 238, and other pattern matching techniques, so that a tilted finger or shape will still match to a shape in the shape database 239. In general, for example, the least mean squares difference between the detected shape and the stored shape can be found, to obtain a match at any shape orientation

The shape database can be stored in memory 221.

The time profile can also be monitored at 240. The profile can represent the way that a person actuates a control as compared with the way that random events will look. For example, a line of heat that moves slowly is likely the sun casting a sunlight line, while a shape that comes quickly is more likely a command.

Finding an shape such as 237 in the shape database at an appropriate time profile can cause execution of a command at 245, where the command is that command associated with the area (e.g., area 103).

In one embodiment, the surface 100 need only be any surface that conducts heat. Therefore, a metal, glass, carbon, or other surface can be used.

Another embodiment, also in contemplated to be encompassed within the FIG. 3 embodiment, forms tunnels within the material of the touchscreen. Each tunnel extending from the front to the back of the material. The tunnels are arranged in the form of an array, for example, and form sensing “pixels” that represent the change in characteristic at an area of sensing. In FIG. 3, the touchable surface 300 has a number of openings 301, 302 or tunnels which extend between the inside and outside of the touch screen. Each tunnel such as 303 forms a sensing area 315 on the outside of the surface 300, and extends to a sensor 310 on the inside 316.

The tunnels can be formed by fibers, such as carbon or diamond nanotubes, or by optical fibers.

In one embodiment, each nanofiber such as 303 is formed of a temperature conducting material such as diamond or carbon nanofibers. In this way, pressing against the surface with a finger or other object causes a change in temperature at the outer surface 300. That temperature change is conducted by the nanofiber, e.g. 301, to the inner surface and sensed by an infrared sensor 310.

The front surface of the screen is completely rigid and non-deformable. However, the areas where the tunnels open to the front surface may not be as rigid as the rest of the screen, due to any glue or other attachment mechanism needed to attach the tunnels to the front surface.

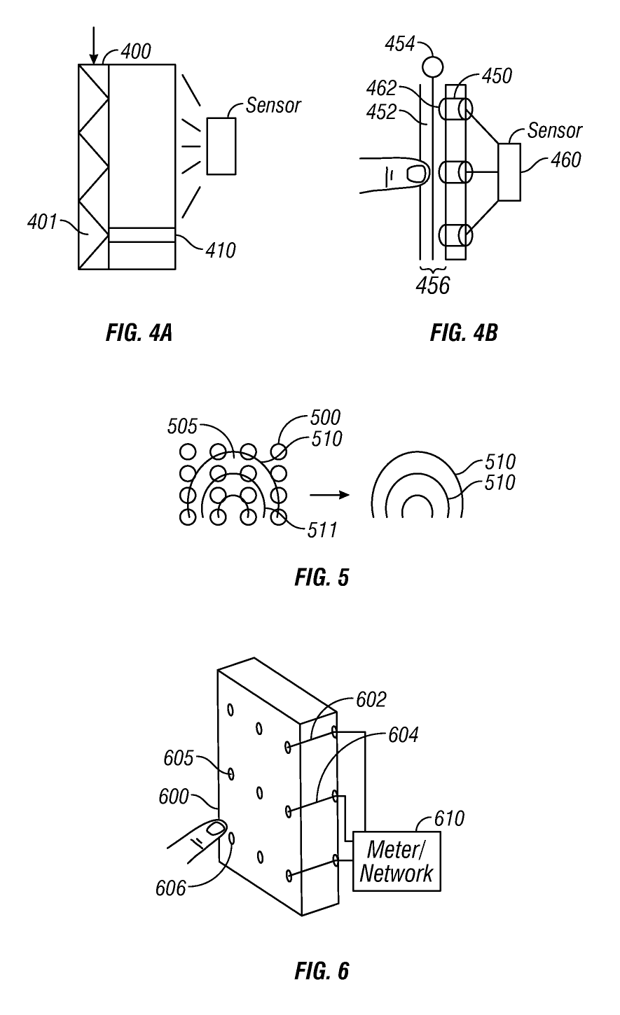

In another embodiment, shown in FIGS. 4A and 4B, the tunnels can be filled with light conducting material. The front surface 400 is lit by an illumination which can be ambient or other illumination of the front screen, or can be a light that passes through a light pipe to illuminate all or some of the light-transparent face 400 by internal reflection 401. A finger or other object can either shadow the illumination or defeat the total internal reflection. Hence the presence of the object changes the light environment near the front face. In this embodiment, the tunnels can be formed of light transmitting fibers 410, e.g., optical fibers, which tunnel the light change to the rear face.

FIG. 4B illustrates another embodiment in which fiber-optic materials fill the tunnels such as 450. In the FIG. 4B embodiment, light, e.g, focused light or a laser beam 452 from a light source 454 is passed through an area 456 that comes near the fiber-optic tunnels, e.g., passes over the tunnels. Placing the finger anywhere on the screen casts a shadow that changes a profile seen by an imager 460 that is looking at the collection of tunnels. Therefore, the finger's position at or near the surface of the screen can be detected by the profile seen by the collection of tunnels. In this embodiment, there may be lenses 462 at the front of the fiber-optic devices. These lenses may image the area near the finger.

In this embodiment, a single scanning sensor 460 is used in place of the array of sensors. In general, any of the embodiments described herein can use a single scanning sensor to receive all of the information as shown in FIG. 4B or can use multiple sensors.

In another embodiment, the infrared sensors can be on the surface, so that bringing the finger close to the surface activates the sensors directly.

The tunnels, in any of the embodiments described herein, can be spaced apart by any distance. By putting them closer together, however, more spatial resolution about the area can be received. The embodiments can look for a specified shape, e.g. the shape of a finger or the shape or a stylus. More spatial resolution can allow finger features to be distinguished. Another embodiment can use one tunnel per actuation area.

In an embodiment, the touch sensor can be “trained” to recognize a shape or specified pattern. In one embodiment shown in FIG. 2C, a training routine is carried out. This training may be used to indicate new shapes or maps to be added to the map database.

At 250, a user enters a code as a training code indicating that training is about to be carried out. This may be a pin code, a password, or a sequence of actions, e.g., tap tap tap in the same spot.

The system responds at 255 by indicating it is in training mode, e.g., by beep or a display. The user then uses a desired finger or implement at 260 to touch any key with a desired shape, e.g., a desired finger, object such as a stylus, or other. The shape that is detected is stored at 265, and can be recognized later as one of the authorized shapes at 237 to execute a command at 245.

In one embodiment, the control can be used to carry out an isomorphic control.

FIG. 5 shows an array of temperature conducting fibers such as 500, on the front surface of the detector of any of the detector embodiments, such as the FIG. 3 or FIG. 4 embodiments. In this embodiment, the array should have sufficient spatial resolution to allow detecting ridges of a fingerprint such as the one shown as 505. By placing the finger on the touch-tunnel surface, areas of the skin where the fingerprint high points are located selectively touch the sensor. For example, ridges 510 actually touch the sensor surface, while spaces between the ridges such as 511 are normally held spaced above with the sensor. This causes the sensor to detect the increased heat from the locations where the fingers touch. The increased heat forms a map indicative of where the ridges are touching the surface. This map looks like the fingerprint.

The fingerprint can be compared against a trained fingerprint, using conventional fingerprint comparison techniques.

This system can be trained so that certain fingerprints actuate the control and others do not. This allows an isomorphic control. For example, only registered fingerprints will operate the unit.

The isomorphic control can be used for security, for example, so that only registered users can control the item. Unlike access style controls, however, this system can be control specific—for example, it may allow turn on by anyone, but only allow turn off or temperature adjust by certain people.

Another embodiment allows the isomorphic control to minimize an amount of detail needed to control isomorphically. The isomorphism can be any biometric characteristic—for example, it can be control by finger size. This produces the advantage that only adults with fingers of a specified size can be used to control the unit. For example, when controlling an oven, only adult finger sizes can control the oven. The adults can train with their fingers to allow those size fingers to control the oven. The training produces shapes that are stored in the memory, and the controller later looks for the size of the fingers that have been stored. When the user touches the screen, the size of their finger is used to compare against the other shapes, and only fingers having a similar size will compare successfully against shapes stored in the memory.

Other techniques can be used to store the shapes. Moreover, when sensing finger shapes, other techniques other than the environmental tunneling described as one embodiment can be used to sense characteristics.

For example, the shapes can be stored as outer perimeters representing the outer extent of the finger, as compared with the detailed information of the fingerprint. Information can store shapes representative of any or all of the different ridges such as shown in FIG. 5, and recognition of any of them can actuate the isomorphic control. For example, ridge 510 only or ridge 511 only can actuate the control.

The above is embodiments have described the use of temperature conducting fibers or tubes that extend from the outside to the inside. In an embodiment, the nanotubes can be of any material that can conduct any kind of environmental change. In embodiments, the material in different tunnels can have different characteristics. The above has described in detail how different kinds of heat conductive materials such as diamonds and carbon nanotubes can be used. In another embodiment, however, the heat conducting material or the strings can be electrically conducting materials.

FIG. 6 shows another embodiment, in which the materials are used as a tuned antenna. The tunnels are filled with conductive wires, such as copper wires 602, 604. Each pair of wires forms an antenna. The meter/mux 610 changes a connection between different pairs of wires at different times. Each pair of wires has a tuning, e.g., the resonant frequency of the system.

When an object, such as a finger, approaches the antenna, the frequency of the finger may change the tuning. For example, the user's finger being put in the location 600 causes cross talk between two elements 605, 606, in the same way that sometimes approaching an electronic device causes a “hum” to emanate from the device.

In one embodiment, the antennas are maintained at a resonant phased array, and the resonance of the human body coming into the area changes the resonance in the area of that phased array antenna. Human body resonance is between 5 and 10 Hz, and this changes the resonance of the antenna in the area of that antenna portion. By detecting the resonant frequency change in the area, the system can detect the position, for example, of the finger.

Note that many of these embodiments sense changes in the environment of at or near the front surface of the screen. In many of these embodiments, such as the resonant frequency changing embodiment and the optical embodiments, as well as the temperature sensing embodiment, the finger can be sensed before it actually touches the computer screen. Therefore, in this embodiment, a system can detect a finger coming near the touch screen rather than actually touching the touch screen.

Another embodiment uses the closeness of the finger to provide a target like effect to assist the user in determining where they are going to touch the screen. As a user brings their finger towards a touchscreen, especially one that many have relatively small touching areas, it is often difficult to touch the right spot. This is often a matter of eye-hand coordination, and typically little user feedback is given to the user when they are trying to touch a touch screen of this type. According to an embodiment, the inventor recognized that feedback on the user's finger position can be very helpful to assist the user in touching the right location on the screen. This can allow a user to use a touchscreen more quickly, as they view the target effect described herein.

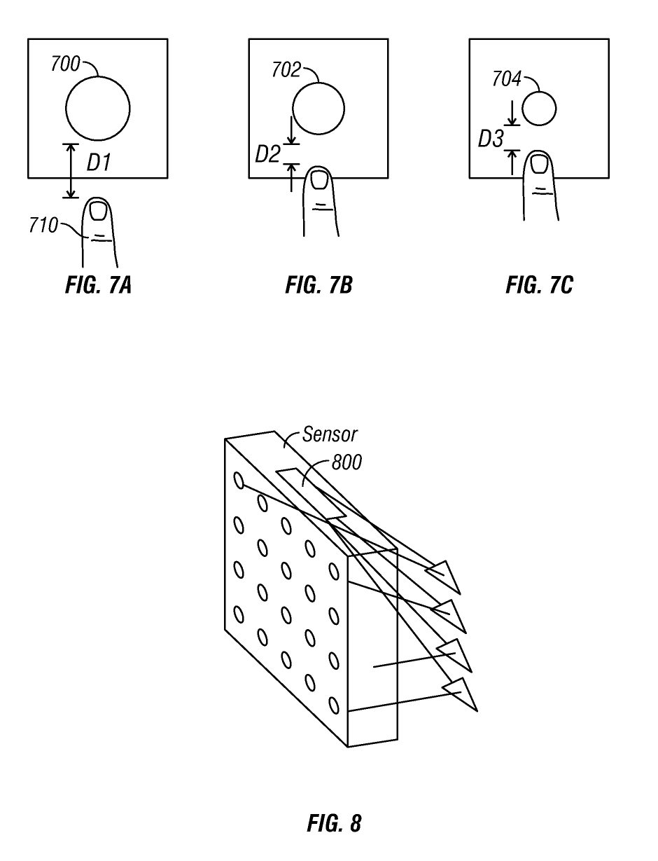

FIGS. 7A-7C show an embodiment that allows this function. When the finger 710 is at a first distance D1 from the screen, it is sensed by the sensor, and causes a large ring 700 to be displayed surrounding an area where the finger would touch if it maintained its current trajectory. The finger continues to move closer, and in FIG. 7B, the finger is a second distance D2 from the touch screen, where D2 is less than D1. At this time, a second target ring 702 is displayed, this second ring smaller than the first target ring. The finger continues, and reaches a distance D3 in FIG. 7C. Since the finger is continually being moved, the rings appear one after the other, providing the illusion of an animation of rings of a target, zeroing in on a target where the finger will hit. This provides needed feedback to the user.

This embodiment can be carried out using any of the noncontact embodiments noted in this application, and can alternatively be done by using a camera that senses the presence of the finger, in conjunction with any conventional touchscreen, e.g, one that deforms.

In the embodiments, the sensors can be behind the screen, near or adjacent to the locations of the tunnels. Another embodiment may channel the information from the tunnel to some other area, e.g., on the edge or edges of the screens, to put the sensors at that edge. FIG. 8 shows an embodiment where there is a single sensor that multiplexes between checking each of the tunnels. FIG. 8 shows miniature prisms reflecting the tunneled radiation, but other radiation systems can be used, including light pipes, temperature-conducting wire, or electrically conducting wire.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, while the above describes a touch screen, this system can be used for any device that detects actuation, e.g., a signature detector or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A sensing system that senses an actuation in a specific area, comprising:
a screen having an actuatable surface defining a front side, and also having a rear side, wherein said actuatable surface includes a plurality of areas, any of said areas which can be actuated to request a function associated with said any of said areas; and
a sensor, adjacent the rear side of said screen detecting a change in environment on the front side of the screen, wherein said screen conducts said change in environment from said front side to said rear side.

2. A system as in claim 1, wherein said screen includes a plurality of tunnels which extend therethrough, each tunnel formed of a different material than the remainder of the screen, where said tunnels conduct said change in environment.

3. A system as in claim 2, wherein said tunnels are formed of heat conductive material.

4. A system as in claim 2, wherein said tunnels are formed of light conducting material.

5. A system as in claim 1, wherein said change of environment is a resonant frequency.

6. A system as in claim 1, wherein said actuable surface is rigid and not deformable, such that said change of environment is detected without deforming said actuable surface.

7. A system as in claim 1, further comprising a memory that stores shapes, and an actuation detection part that is responsive to sensing by said sensor to detect shapes of said change in environment at said front surface, and commanding said actuation only when said shape matches an authorized shape in said memory.

8. A system of detecting actuations, comprising:
a surface defining a front surface adjacent an area at which actuations will be sensed, said actuations being sensed by a selection of an area of said front surface by an interaction between an item and an area of said front surface, where different areas on said front surface represent different commands being actuated; and
a sensor that detects an actuation via said interaction, before said item actually touches said front surface.

9. A system as in claim 8, wherein said actuation is sensed by conducting an environmental change from an area adjacent said front surface to a sensing area on another side of said surface.

10. A system as in claim 7, wherein said surface includes tunnels therein which tunnel said environmental change from said front surface to said sensing area.

11. A system as in claim 8, further comprising a memory that stores shapes, and wherein said sensor detects said actuation by detecting a shape of said item based on said environmental change, and commanding said actuation only when said shape matches an authorized shape in said memory.

12. A system as in claim 11, wherein said memory also stores unauthorized shapes, and not allowing said actuation when said shape matches an unauthorized shape.

13. A system as in claim 10, wherein said surface between said tunnels is completely rigid and non deformable.

14. A method comprising:
detecting a change of environment at a front side of an actuatable surface, using a sensor that is on a rear side of said actuatable surface, by conducting said change of environment from said front side to said rear side;
detecting an area at which said change of environment occurred, using said sensor; and
commanding an actuating of a function associated with said area, based on said detecting an area.

15. A method as in claim 14, wherein said change of environment includes an item touching said front side.

16. A method as in claim 14, wherein said change of environment includes an item coming near said front side or said item touching said front side.

17. A method as in claim 14, wherein said conducting comprises conducting said change of environment through any of a plurality of tunnels which extend through said actuable surface, each tunnel formed of a different material than the remainder of the screen.

18. A method as in claim 14, wherein said tunnels are formed of heat conductive material, and said conducting comprises conducting heat.

19. A method as in claim 14, wherein said tunnels are formed of radiation conducting material, and said conducting comprises conducting radiation.

20. A method as in claim 14, wherein said change of environment is carried out without deforming said front surface.

21. A method as in claim 14, further comprising detecting a shape of an item doing said actuation.

22. A method as in claim 21, and further comprising detecting a shape of a memory that stores shapes, and wherein said commanding is only done when said detected shape matches an item in said memory.

23. A touch screen comprising;
a surface with actuable areas, that is actuated by interacting with said surface using an item to interact with an area of said surface, to command a function from at least one of said areas that were interacted with by said item, without deforming the surface.

24. A touch screen as in claim 23, wherein said item touches said surface, but does not deform said surface.
